(19) United States
(12) Patent Application Publication
(10) Pub. No.: US 2013/0106552 A1
(43) Pub. Date: May 2, 2013

(54) INDUCTOR WITH MULTIPLE POLYMERIC LAYERS

(71) Applicants: Robert E. Fontana, JR., San Jose, CA (US); William J. Gallagher, Ardsley, NY (US); Philipp Herget, San Jose, CA (US); Eugene J. O'Sullivan, Nyack, NY (US); Naigang Wang, Ossining, NY (US); Bucknell C. Webb, Ossining, NY (US)

(72) Inventors: Robert E. Fontana, JR., San Jose, CA (US); William J. Gallagher, Ardsley, NY (US); Philipp Herget, San Jose, CA (US); Eugene J. O'Sullivan, Nyack, NY (US); Naigang Wang, Ossining, NY (US); Bucknell C. Webb, Ossining, NY (US)

(73) Assignee: INTERNATIONAL BUSINESS MACHINES CORPORATION, Armonk, NY (US)

(21) Appl. No.: 13/287,942

(22) Filed: Nov. 2, 2011

(51) Int. Cl. H01F 5/00; H01F 5/06

(52) U.S. Cl. 336/200

(57) ABSTRACT

A thin film inductor according to one embodiment includes a bottom yoke; a first insulating layer above the bottom yoke; one or more conductors above the bottom yoke and separated therefrom by the first insulating layer; a second insulating layer above the one or more conductors; a third insulating layer above the second insulating layer; and a top yoke above the third insulating layer. A thin film inductor according to another embodiment includes a bottom yoke; a first insulating layer above the bottom yoke, the first insulating layer being polymeric; one or more conductors above the bottom yoke and separated therefrom by the first insulating layer; an upper insulating layer above the one or more conductors, the upper insulating layer being polymeric; and a top yoke above the second insulating layer.

### BACKGROUND

The present invention relates to inductors, and more particularly, this invention relates to thin film ferromagnetic inductors.

The integration of inductive power converters onto silicon is one path to reducing the cost, weight, and size of electronics devices. One main challenge to developing a filly integrated power converter is the development of high quality thin film inductors. To be viable, the inductors should have a high Q, a large inductance, and a large energy storage per unit area.

### SUMMARY

A thin film inductor according to one embodiment includes a bottom yoke; a first insulating layer above the bottom yoke; one or more conductors above the bottom yoke and separated therefrom by the first insulating layer; a second insulating layer above the one or more conductors; a third insulating layer above the second insulating layer; and a top yoke above the third insulating layer.

A thin film inductor according to another embodiment includes a bottom yoke; a first insulating layer above the bottom yoke, the first insulating layer being polymeric; one or more conductors above the bottom yoke and separated therefrom by the first insulating layer; an upper insulating layer above the one or more conductors, the upper insulating layer being polymeric; and a top yoke above the second insulating layer.

A system according to one embodiment includes an electronic device; and a power supply or power converter incorporating a thin film inductor as recited above.

Other aspects and embodiments of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

FIG. 1 is a perspective view of a thin film inductor according to one embodiment.

FIG. 2A is a top view of a non coupled thin film inductor according to one embodiment.

FIG. 2B is a cross sectional view of a non coupled thin film inductor according to one embodiment.

FIG. 2C is a cross sectional view of a non coupled thin film inductor according to one embodiment.

FIG. 3A is a top view of a coupled thin film inductor according to one embodiment.

FIG. 3B is a cross sectional view of a coupled thin film inductor according to one embodiment.

FIG. 3C is a cross sectional view of a coupled thin film inductor according to one embodiment.

FIG. 3D is a top view of a coupled thin film inductor according to one embodiment.

FIG. 3E is a top view of a coupled thin film inductor according to one embodiment.

FIG. 4A is a top view of a thin film inductor according to one embodiment.

FIG. 4B is a cross sectional view of a thin film inductor according to one embodiment.

FIG. 4C is a cross sectional view of a thin film inductor according to one embodiment.

FIG. 5A is a top view of a thin film inductor according to one embodiment.

FIG. 5B is a cross sectional view of a thin film inductor according to one embodiment.

FIG. 5C is a cross sectional view of a thin film inductor according to one embodiment.

FIG. 5D is a cross sectional view of a thin film inductor according to one embodiment.

FIG. 6 is a simplified diagram of a system according to one embodiment.

FIG. 7 is a simplified circuit diagram of a system according to one embodiment.

FIG. 8 is a flowchart of a method according to one embodiment.

FIG. 9 is a flowchart of a method according to one embodiment.

FIG. 10 is a flowchart of a method according to one embodiment.

FIG. 11 is a flowchart of a method according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

In the drawings, like elements have common numbering across the various Figures.

The following description discloses several preferred embodiments of thin film inductor structures having conductors surrounded by ferromagnetic yokes, wherein polymeric layers of insulation may be used to increase the space between the conductors and the yokes. The resulting inductor has an increased coupling efficiency, an improvement in the planarity of the top yoke over the coil, and/or minimized coil shortening between the coil and the yokes.

The integration of inductive power converters onto silicon is one path to reducing the cost, weight, and size of electronics devices. To reduce cost it is critical that an on chip power converter achieve a high power density. One way to meet these needs is by adopting a multi-phase conversion strategy using coupled inductors. Converters may also use traditional thin film inductors, usually spiral in shape, with two arms.

Converters using coupled inductors may be designed such that neighboring phases create DC flux in opposing directions. Since the opposing fluxes cancel, a much higher current can be reached before the core is saturated. The amount of cancelation that can be achieved is determined by the coupling constant. An inductor designed with a high coupling constant can greatly increase the achievable current per unit area.

Additionally, thin film inductors should store a large amount of energy per unit area to fit in the limited space on silicon. A ferromagnetic material enables an inductor to store more energy for a given current. Another benefit of a ferromagnetic material is a reduction in losses. One of the main loss mechanisms in an inductor comes from the resistance of the conductors. This loss is proportional to the square of the current. Using a ferromagnetic material reduces the current required to store a given amount of energy and thus can reduce the total losses.

However, ferromagnetic materials also introduce some disadvantages. The magnitude of the fields in a ferromagnetic material is limited by saturation. The saturation of the yoke therefore limits the maximum current and the maximum energy that the inductor can store.

A thin film inductor according to one general embodiment includes a bottom yoke; a first insulating layer above the bottom yoke; one or more conductors above the bottom yoke and separated therefrom by the first insulating layer; a second insulating layer above the one or more conductors; a third insulating layer above the second insulating layer; and a top yoke above the third insulating layer.

A thin film inductor according to another general embodiment includes a bottom yoke; a first insulating layer above the bottom yoke, the first insulating layer being polymeric; one or more conductors above the bottom yoke and separated therefrom by the first insulating layer; an upper insulating layer above the one or more conductors, the upper insulating layer being polymeric; and a top yoke above the second insulating layer.

A system according to one general embodiment includes an electronic device; and a power supply or power converter incorporating a thin film inductor as recited above.

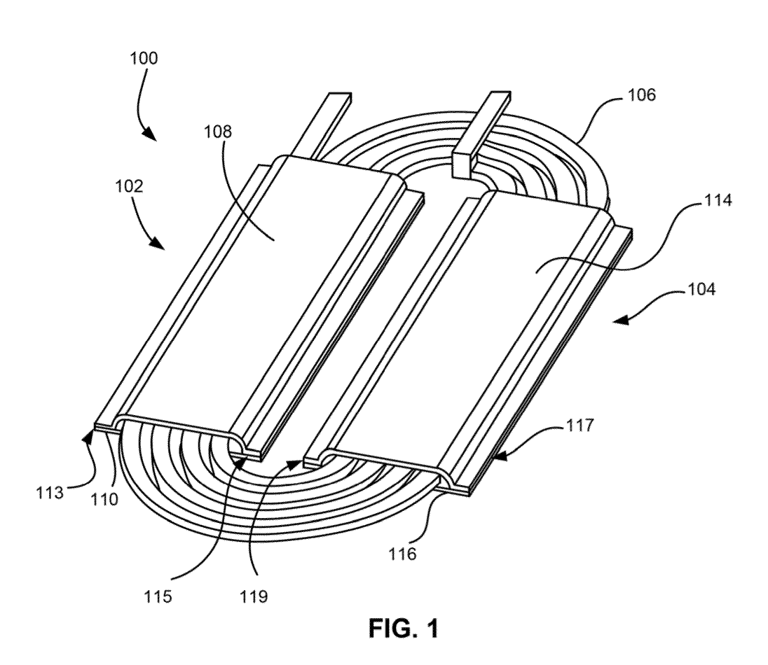

Referring to FIG. 1, there is shown one embodiment of a thin film inductor 100 having two arms 102, 104 and a conductor 106 passing through each arm. The conductor in this case has several turns in a spiral configuration, but in other approaches may have a single turn. In further approaches, multiple conductors, each having one or more turns, may be employed.

A first ferromagnetic top yoke 108 and bottom yoke 110 wrap around the one or more conductors in a first of the arms 102. On either side of the conductor 106 are via regions 113 and 115, where the ferromagnetic top yoke 108 and ferromagnetic bottom yoke 110 are coupled through a low reluctance path.

A second pairing of a ferromagnetic top yoke 114 and bottom yoke 116 wraps around the one or more conductors in a second of the arms 104. Furthermore, ferromagnetic top yoke 114 and ferromagnetic bottom yoke 116 are coupled together through a low reluctance path at the via regions 117, 119.

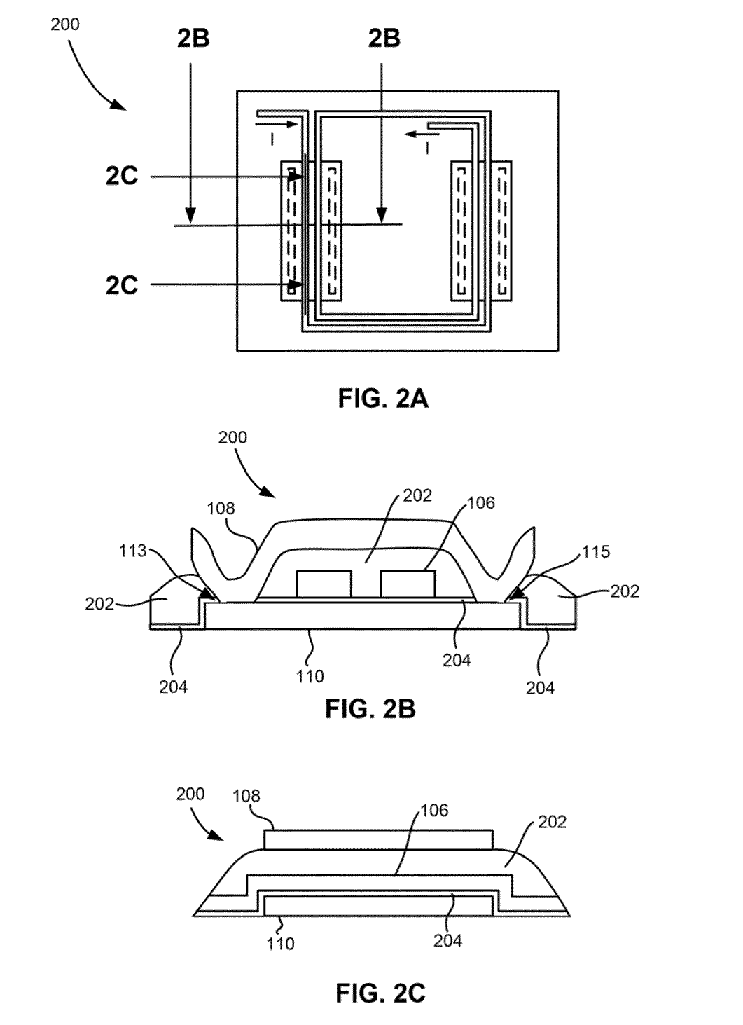

FIG. 2B depicts a cross sectional view of an embodiment of a common non coupled, thin film inductor 100, as seen in FIG. 2A. The inductor 200 has a top yoke 108 and a bottom yoke 110 which wrap around the one or more conductors 106, through which there is a current flowing as seen in FIG. 2A. On either side of the conductor 106 are via regions 113 and 115, where the ferromagnetic top yoke 108 and ferromagnetic bottom yoke 110 are coupled through a low reluctance path. This particular configuration is characterized by the use of a thick insulating layer 202, separating the coil from the top yoke that is sometimes organic or polymeric in nature, and a thin dielectric insulator 204, that separates the bottom yoke from the coil.

FIG. 2C depicts a cross sectional view of a thin film inductor 200, as seen in FIG. 2A. The inductor 200 has a top yoke 108 and a bottom yoke 110. This particular configuration is characterized by the use of a thick insulating layer 202, separating the conductor 106, from the top yoke that is sometimes organic or polymeric in nature, and a thin dielectric insulator 204, that separates the bottom yoke from the conductor 106.

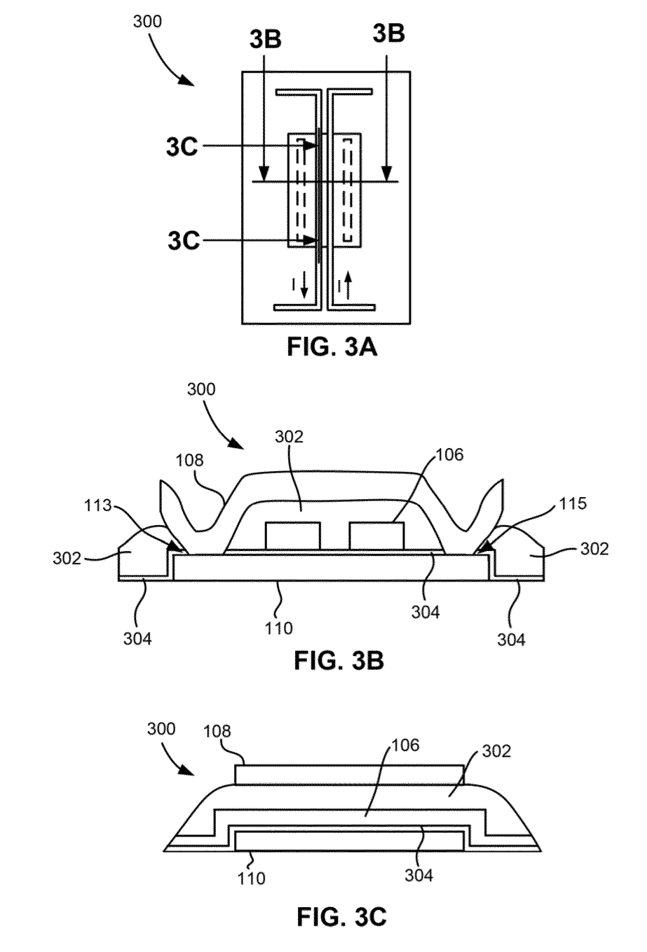

Similarly, FIG. 3B depicts a cross sectional view of an embodiment of a common coupled, thin film inductor 100, as seen in FIG. 3A. The inductor 300 has a top yoke 108 and a bottom yoke 110 which wrap around the one or more conductors 106, through which currents are flowing, typically in opposite directions, as seen in FIG. 3A. On either side of the conductor 106 are via regions 113 and 115, where the ferromagnetic top yoke 108 and ferromagnetic bottom yoke 110 are coupled through a low reluctance path. This particular configuration is characterized by the use of a thick insulating layer 302, separating the coil from the top yoke that is sometimes organic or polymeric in nature, and a thin dielectric insulator 304, that separates the bottom yoke from the coil.

FIG. 3C depicts a cross sectional view of a thin film inductor 300, as seen in FIG. 3A. The inductor 300 has a top yoke 108 and a bottom yoke 110. This particular configuration is characterized by the use of a thick insulating layer 302, separating the conductor 106, from the top yoke that is sometimes organic or polymeric in nature, and a thin dielectric insulator 304, that separates the bottom yoke from the conductor 106.

FIG. 3D depicts a configuration 350 comprised of multiple coupled thin film inductors 360. This configuration shows one way to arrange inductors for a power converter. The particular embodiment shown here is for a 4 phase converter, but in various embodiments, any number of phases may be used, as would be clear to someone skilled in the art upon reading the present disclosure. Coupled inductors 360 may be the same or similar to any configuration of the thin film coupled inductors described herein.

In one approach, a power converter may configure the conductors so that they may be driven such that the two conductors within each inductor have current flowing in opposite directions. According to one approach, the inductors 360 may be connected such that passing current through any wire will cause two inductors to be energized.

FIG. 3E depicts another alternate configuration 370 which achieves the same purpose as the configuration shown in FIG. 3D.

The design configurations corresponding to both the coupled and non-coupled conductors, as depicted in FIGS. 2A-3C have several deficiencies. These include having the thin insulator separating the bottom yoke from the coil which does not provide good step coverage or insulation over the bottom yoke edge, thus resulting in the potential for the coil and the bottom yoke to short. Similarly, the single polymer insulating layer may not provide sufficient coverage over the edge of the coils resulting in coil to top yoke shorts. Moreover, the thin insulator that separates the bottom yoke from the coil results in a small top to bottom yoke separation that results in a smaller coupling constant in coupled inductor designs. Additionally, the single polymer insulation that covers the coils and insulates the coil from the top yoke may not be sufficiently planar and this degrades the magnetic properties of the top yoke. Finally, the single polymer insulating layer results in a reduced top to bottom yoke separation that results in a smaller coupling constant in coupled inductor designs.

Note that FIG. 3A illustrates a simple embodiment. In some embodiments, several such base units may be used together to achieve various embodiments, such as a multi phase power converter. See, e.g., FIG. 3D.

However without wishing to be bound by any theory, it is believed that incorporating multiple layers of polymeric insulation in thin film inductors, whether coupled or non coupled, results in an improvement of the magnetic characteristics of the inductor.

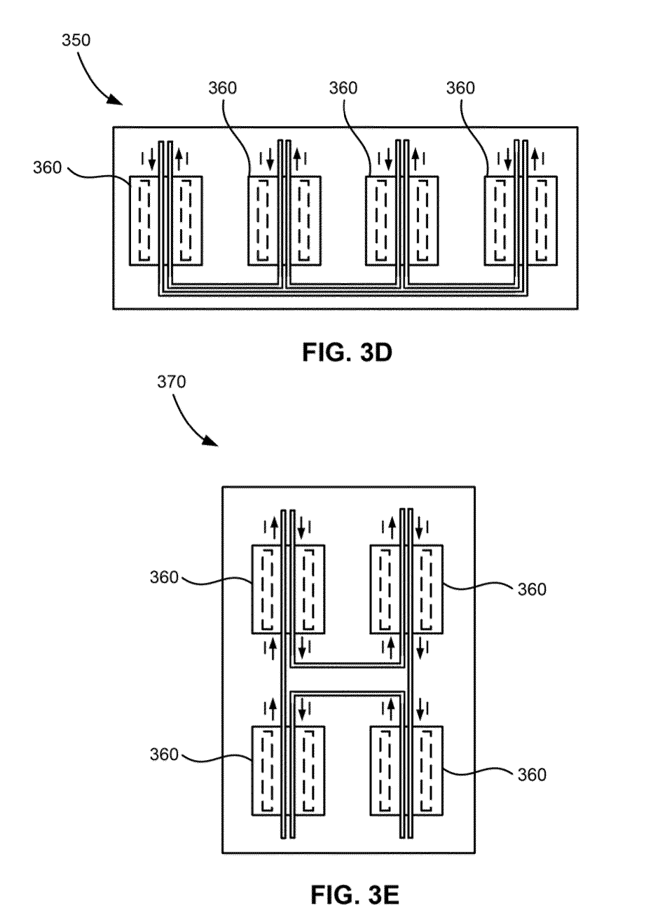

FIG. 4B depicts a cross sectional view corresponding to one embodiment of a coupled thin film inductor 100, as seen in FIG. 4A. The inductor 400 has a top yoke 108 and bottom yoke 110 which wrap around a thick bottom insulating layer, 404 and top insulating layer, 402. This particular configuration is characterized by the use of the thick polymeric or organic insulating layer 404 in conjunction with the polymeric or organic layer 402. The use of these two polymeric layers create some of the benefits described. Above the insulating layer 404 are the conductors 106. On either side of the conductor 106 are via regions 113 and 115, where the ferromagnetic top yoke 108 and ferromagnetic bottom yoke 110 are coupled through a low reluctance path.

FIG. 4C depicts a cross sectional view of a thin film inductor 400, as seen in FIG. 4A. The inductor 400 has a top yoke 108 and a bottom yoke 110. This particular configuration is characterized by the use of a thick insulating layer 404, separating the conductor 106 from the bottom yoke, where the insulating layer 404 is organic (including polymeric) in nature. A thick dielectric insulator 402, also polymeric, separates the top yoke from the conductor 106.

In a variation, the general embodiment of FIGS. 4A-4C may be applied to a coupled configuration, as would be apparent to one skilled in the art upon reading the present disclosure. Moreover, any number of coil turns may be used, such as 2, 3, 4, 5, 6, 10, 20, etc. and any value in between as would be apparent to one skilled in the art. Additionally, the yokes in this and other embodiments may be constructed of any soft magnetic material, such as iron alloys, nickel alloys, cobalt alloys, ferrites, etc. The yokes may also be made of laminated films.

In the via regions having the low reluctance path between the top and bottom yokes, the magnetic layers may be in direct contact, or may be separated by a thin nonmagnetic layer, which may be any nonmagnetic material known in the art, such as tungsten, copper, gold, alumina, silicon oxides, polymers, etc.

Any electrically insulating material known in the art may be used in this or any other embodiment for any of the insulating layers. Illustrative electrically insulating materials include alumina, silicon oxides, silicon nitride, resists, polymers, etc.

The present embodiment provides several benefits including increased step coverage over the bottom yoke which improves the conformality of the coil(s) over the yoke and greatly reduces the probability of coil to yoke shorts at edges of the yoke along its outside perimeter. Similarly, the embodiment provides increased separation between the bottom yoke and the coil(s) which minimizes the probability of shorts between the coil and the bottom yoke. The bottom yoke to top yoke separation is also increased, thus improving the coupling performance in approaches of the present embodiment which utilize coupled inductors. Coupled inductor approaches also increase the aspect ratio, which also increases the achievable coupling constant of the inductor. Finally, the present embodiment removes the need for the thin dielectric insulating layer in the structure.

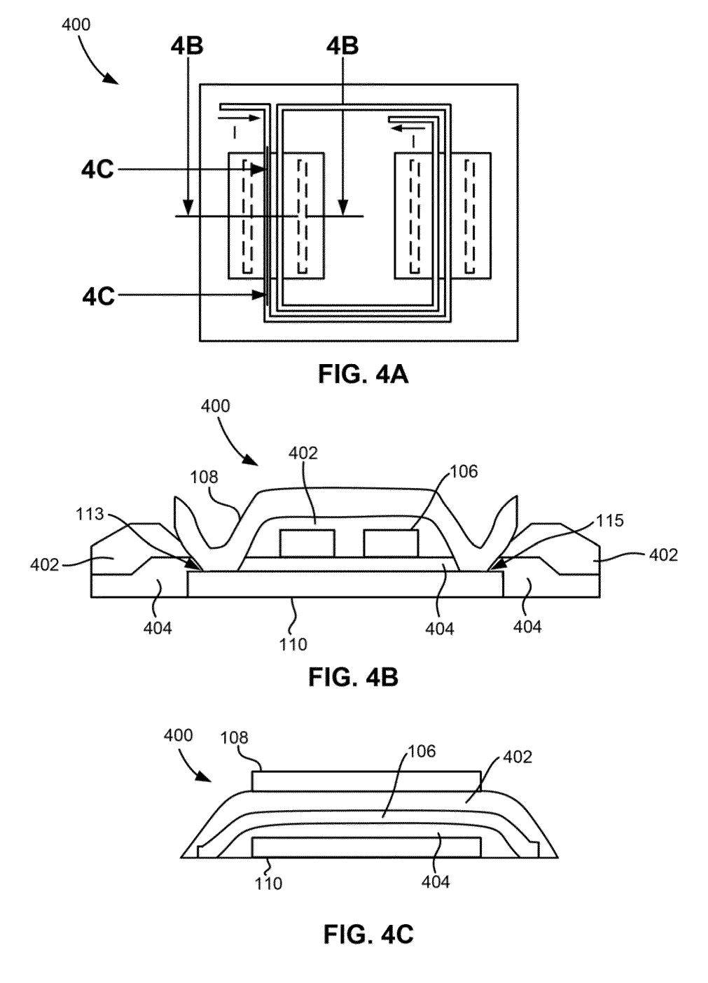

FIG. 5B depicts a cross sectional view corresponding to one embodiment of a thin film inductor 500, as seen in FIG. 5A. The inductor 500 has a top yoke 108 and bottom yoke 110 which sandwich a thick bottom insulating layer 504 and top insulating layers 502 and 506. This particular configuration is characterized by the use of a thick polymeric insulating layer 502, coupled with an adjoining polymeric insulating layer 506, both of which separate the conductor 106, from the top yoke. Beneath these insulating layers 502, 506 are the conductors 106. On either side of the conductor 106 are via regions 113 and 115, where the ferromagnetic top yoke 108 and ferromagnetic bottom yoke 110 are coupled through a low reluctance path.

FIG. 5C depicts a cross sectional view of a thin film inductor 500, as seen in FIG. 5A. The inductor 500 has a top yoke 108 and a bottom yoke 110. This particular configuration is characterized by the use of a thick polymeric insulating layer 502, coupled with an adjoining polymeric insulating layer 506, both of which separate the conductor 106, from the top yoke. One or more of the upper insulating layers is polymeric. A lower insulating layer 504 separates the bottom yoke 110 from the conductor 106. In the embodiment show, this lower layer is also a polymeric insulating layer, however, and other insulating layer as would be known to one skilled in the art may be used.

FIG. 5D depicts a variation of the embodiment of FIG. 5B, according to one embodiment. Particularly, the bottom insulating layer 504 is constructed of two or more layers of insulating material. The layers of the bottom insulating layer 504 may have any type of construction described herein and/or as would be apparent to one skilled in the art upon reading the present disclosure. For example, the layers of the bottom insulating layer may include an oxide, a polymer, etc.

In a variation, the general embodiment of FIGS. 5A-5D may be applied to a non-coupled configuration, as would be apparent to one skilled in the art upon reading the present disclosure. Moreover, any number of coil turns may be used, such as 2, 3, 4, 5, 6, 10, 20, etc. and any value in between.

Preferably, each layer of electrically insulating material has physical and structural characteristics of being created by a single layer deposition. For example, the electrically insulating material may have a structure having no transition or interface that would be characteristic of multiple deposition processes; rather the layer is a single contiguous layer without such transition or interface. Such layer may be formed by a single deposition process such as sputtering, spincoating, etc. that forms the layer of electrically insulating material to the desired thickness, or greater than the desired thickness (and subsequently reduced via a subtractive process such as etching, milling, etc. or reflowed by processes such a baking to get the desired dimensions and material properties.).

Various embodiments provide several benefits such as increasing the bottom yoke to top yoke separation, thus improving the coupling performance in coupled inductors. In some embodiments, the minimum spacing between the coils and the bottom yoke is increased, thus reducing the probability of shorting between coil and bottom yoke. In addition, the added layer of polymeric material in the upper insulating layer provides a more planar surface for the top yoke structure since spaces between coils are now covered with two planarizing spin on processes. Finally, in coupled inductor structures, the aspect ratio of the inductor increases, which increases the coupling constant achievable.

When a second insulating layer is added, and its thickness is increased in a controlled manner, it automatically results in more space, and better coupling, resulting in better efficiency than an inductor with a single insulating layer. The insulating layer below the conductors provides the same advantage, by raising the coils, and everything else being formed above it, resulting in an advantage.

Additionally, when using two insulating layers above the conductors, adding a second upper insulating layer above the first upper insulating layer reduces the topographical features of the surface over which the top yoke is formed, thereby making the top yoke more planar and improving its magnetic properties.

In one approach, the second and third insulating layers of a thin film inductor have different compositions. For example, the second insulating layer of the thin film inductor may include an oxide such as a metal oxide of any type conventionally used as an insulator and the third insulating layer may include an organic material. Furthermore, in one embodiment of the present extent, the third insulating layer of the thin film inductor is polymeric.

In another approach, the first and third insulating layers of a thin film inductor include an organic material. In a preferred embodiment, the first and third insulating layers are polymeric.

Polymeric layers have the advantage of being capable of being applied with spin coating, and as a result, thicknesses in the multiple micron range (e.g., 1 μm to 10 μm or higher or lower) are achievable. The thickness range for the first layer of polymeric insulation applied between the coils and the bottom yoke is preferably sufficient to provide for a continuous and conformal coating over the edges of the bottom yokes. This is most easily achieved with a polymeric thickness that is equal to or greater than the thickness of the bottom yoke, e.g., about 1.5× times the thickness of the bottom yoke. For a yoke thickness of 2 μm the polymer thickness should be ideally in the 2.0 to 3.0 μm range or greater. The thickness range for the additional polymeric insulating layer above the coil layer and below the top yoke, e.g., above the existing polymeric insulating layer and below the top yoke may be selected to optimize coupling, in a coupled inductor structure, to ensure a more conformal surface above the coils for the top yoke, and to ensure a continuous layer of insulation is separating the coil edges from the top yoke. This range of thickness is typically determined by the coil thickness. Illustrative polymer layer thicknesses may be in the 5 μm range, but may be higher or lower.

Polymeric insulators of any type may be used. For example, one class is photo active photoresist that can be spin coated over a structure, exposed and developed to remove the photoresist in unwanted areas, and then hard baked at temperatures in the 200° C. range to harden and stabilize the resist. One advantage of the baking process is that the resist structure shrinks and topography of the final structure is domed with controlled sloped edges, losing its sharp corners. A second class includes non photo active types of polyimides that can be spin coated over a structure and then baked at temperatures in the 200° C. range to harden and stabilize the material. After hardening, a masking step and etch may be used to remove the polyimide in unwanted areas. A disadvantage of the polyimide structure is that it is more difficult to achieve dome-like structures and this doming is usually achieved by using non-anisotropic etch processes during the removal of the polyimide. In both cases a thermal post treatment may be utilized to cause the deformation of the straight edges to become rounded. Consequently, the polymeric layer allows for conformality across the edges.

In yet another approach, the thin film inductor may be a coil inductor. In still another approach, a thin film inductor may be a coupled, or a non-coupled inductor which may have at least one, at least two, etc. or more conductors. In one approach, at least two of the conductors of a coupled inductor may not be electrically connected. In yet another approach, at least one conductor of a non-coupled inductor may be electrically connected together.

In any approach, the dimensions of the various parts may depend on the particular application for which the thin film inductor will be used. One skilled in the art armed with the teachings herein would be able to select suitable dimensions without needing to perform undue experimentation.

In use, the thin film inductors may be used in any application in which an inductor is useful.

In one general embodiment, the thin film inductor includes a bottom yoke; a first insulating layer above the bottom yoke, the first insulating layer being polymeric; one or more conductors above the bottom yoke and separated therefrom by the first insulating layer; for example, the conductor(s) may be formed on the first insulating layer, in channels of the first insulating layer, etc. An upper insulating layer is positioned above the one or more conductors, the upper insulating layer being polymeric. A top yoke is formed above the second insulating layer.

In one approach, the thin film inductor further includes a second insulating layer between the one or more conductors and the upper insulating layer, the second and upper insulating layers have different compositions. Furthermore, in one breadth of the present approach, the second insulating layer of the thin film inductor includes an oxide.

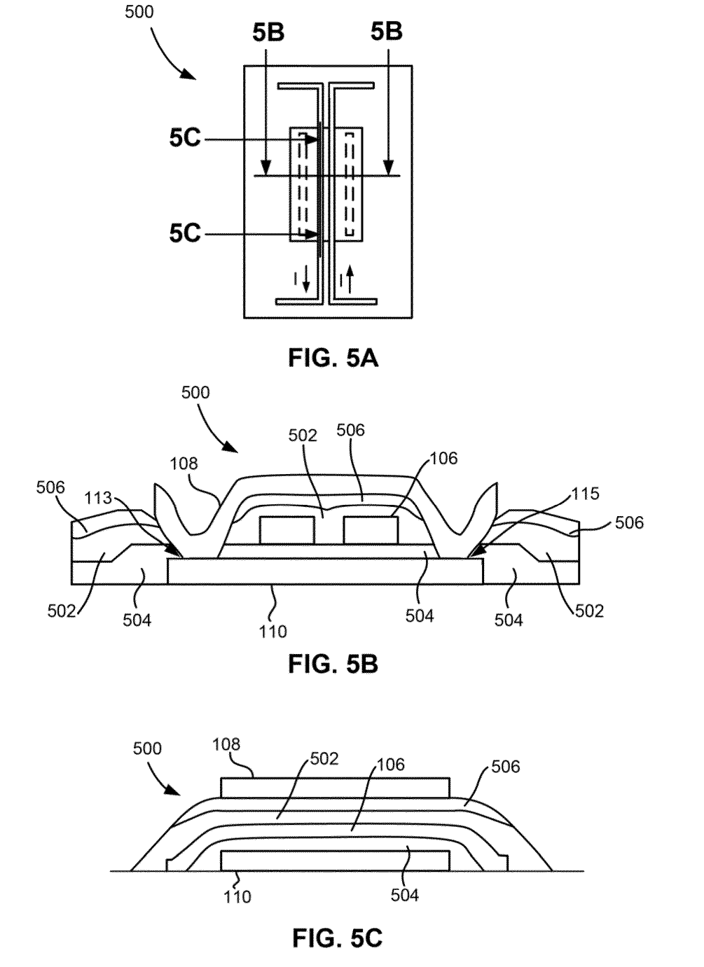

In one general embodiment, depicted in FIG. 6, a system 600 includes an electronic device 602 (which may include any device that uses, produces, or manipulates electricity in some manner, such as circuits, LED lighting, solar panels, power conversion for any power source such as solar panels, a battery, more complex devices, etc.), and a thin film inductor 604 according to any of the embodiments described herein, preferably coupled to or incorporated into a power supply or power converter 606 used by the electronic device. Such electronic device may be a circuit or component thereof, chip or component thereof, microprocessor or component thereof, application specific integrated circuit (ASIC), etc. In further embodiments, the electronic device and thin film inductor are physically constructed (formed) on a common substrate. Thus, in some approaches, the thin film inductor may be integrated in a chip, microprocessor, ASIC, etc.

Additional applications, according to various embodiments include power conversion for LED lighting, power conversion for solar power, etc. For example, one illustrative approach may include a solar panel, a power converter having an inductor as described herein, and a battery.

In other approaches, the thin film inductor may be integrated into electronics devices where they are used in circuits for applications other than power conversion. The system may have the thin film inductor may be a separate component, or physically constructed on the same substrate as the electronic device.

In another approach, the second and third insulating layers of the system have different compositions. For example, the second insulating layer of the system may include an oxide such as a metal oxide of any type conventionally used as an insulator and the third insulating layer may include an organic material. Furthermore, the third insulating layer of the system may be polymeric.

In another approach, the first and third insulating layers of the system include an organic material. In a preferred embodiment, the insulating layers are polymeric. Furthermore, in one approach, the second insulating layer of the system includes an oxide.

In yet another approach, a system, further comprising a second insulating layer between the one or more conductors and the upper insulating layer, the second and upper insulating layers have different compositions.

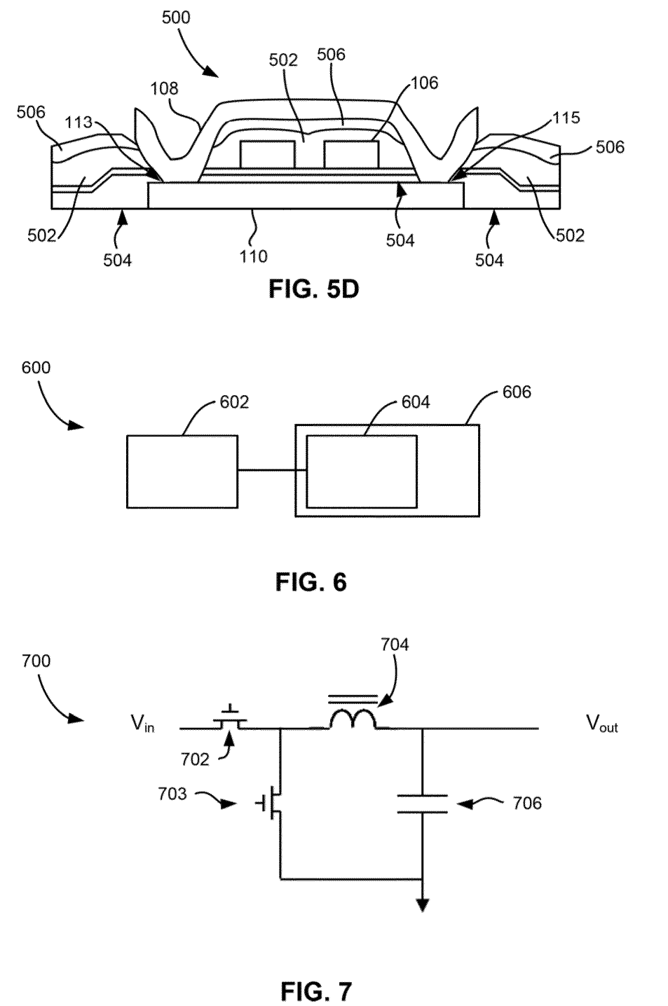

In one illustrative embodiment, depicted in FIG. 7, a buck converter circuit 700 is provided. In this example the circuit includes two transistor switches 702, 703 the inductor 704, and a capacitor, 706. With appropriate control signals on the switches, this circuit will efficiently convert a larger input voltage to a smaller output voltage. The circuit shown in the figure is for a single phase non-coupled power converter. However, similar circuits exist for multiphase and multiphase coupled conversion as would be know to one skilled in the art. In fact, many such circuits incorporating inductors are know to those in the art including circuits for converting a smaller input voltage to a larger output voltage. These types of circuits may be a stand alone power converter, or part of a chip or component thereof, microprocessor or component thereof, application specific integrated circuit (ASIC), etc. In further embodiments, the electronic device and thin film inductor are physically constructed (formed) on a common substrate. Thus, in some approaches, the thin film inductor may be integrated in a chip, microprocessor, ASIC, etc.

In yet another approach, the thin film inductor may be formed on a first chip that is coupled to a second chip having the electronic device. For example, the first chip may act as an interposer between the power supply or converter and the second chip.

Illustrative systems include mobile telephones, computers, personal digital assistants (PDAs), portable electronic devices, etc. The power supply or converter may include a power supply line, a transformer, etc.

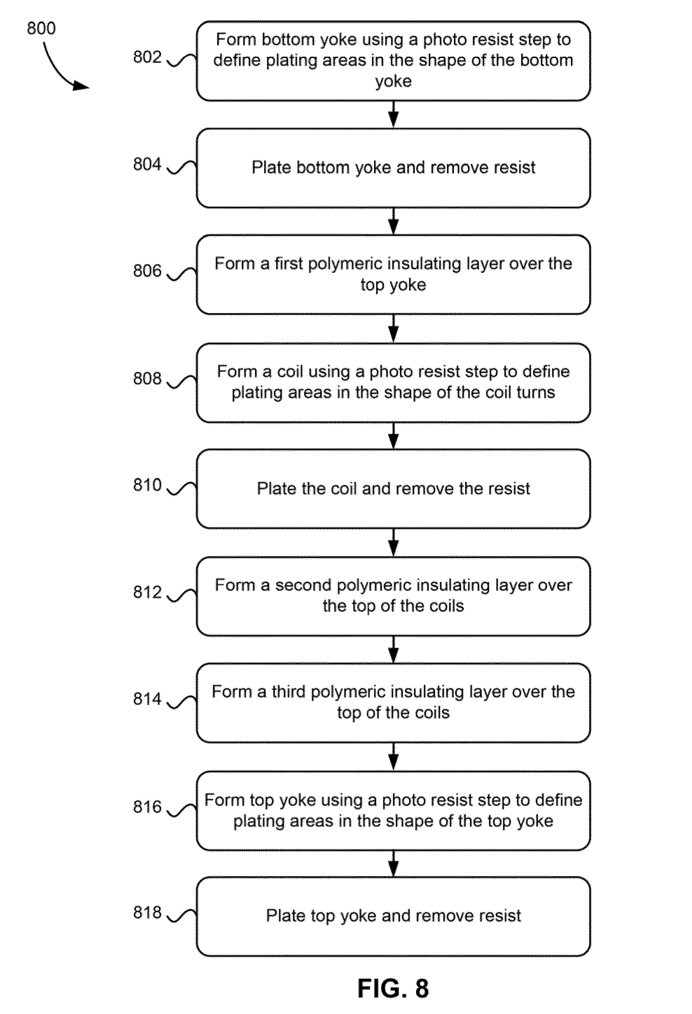

The use of additional polymeric insulating layers adds process steps to the inductor fabrication sequence. However, improvements in inductor magnetic and electrical performance compensate for the increase in complexity. A possible process 800 using photo active polymers in making a thin film inductor according to one embodiment is depicted in FIG. 8. The process 800, in some approaches, may be performed in any desired environment, and may include embodiments and/or approaches described in relation to FIGS. 4A-7. Of course, more or fewer operations than those shown in. FIG. 8 may be performed as would be apparent to one of skill in the art upon reading the present disclosure.

In operation 802, a bottom yoke is formed using a photo resist step to define plating areas in the shape of the bottom yoke. In operation 804, the bottom yoke is plated and resist is removed. A first polymeric insulating layer is formed over the top yoke in operation 806.

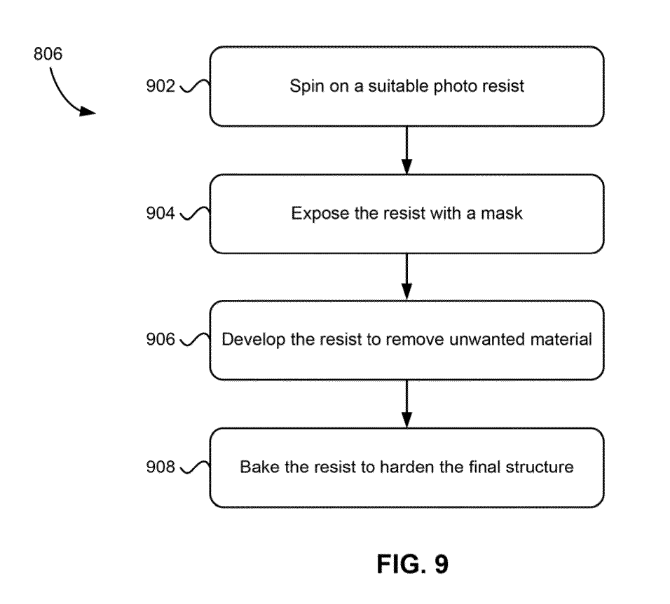

A possible process to perform step 806 of FIG. 8 is depicted in FIG. 9. In operation 902, a suitable photo resist is spun on, and in operation 904, resist is exposed with a mask. The resist is developed to remove unwanted material in operation 906, and in operation 908, the resist is then baked to harden the final structure, where the first polymeric layer may be left covering all surfaces of the first yoke which may exclude the via regions, and include the outer edges of the bottom yoke.

In continued examination of process 800, succeeding step 806, a coil is formed using a photo resist step to define plating areas in the shape of the coil turns in operation 808. In operation 810, the coil is plated and resist is removed. In operation 812 a second polymeric insulating layer is formed over the top of the coils.

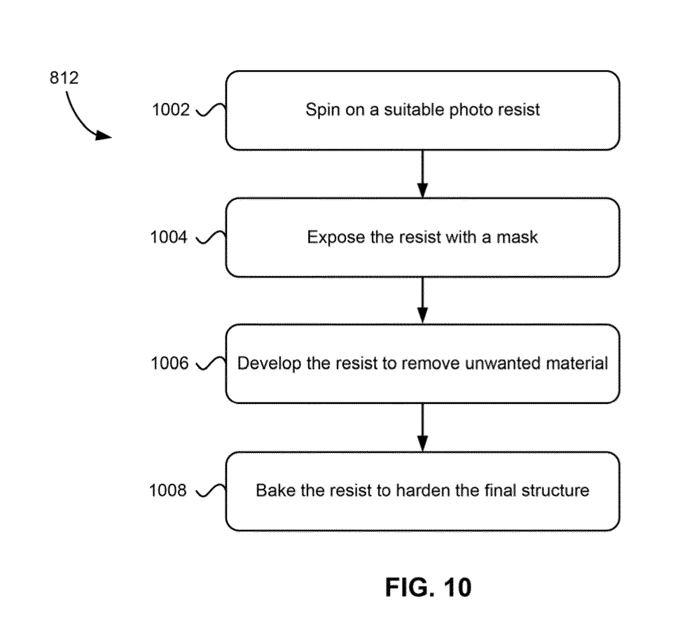

A possible process to perform step 812 of FIG. 8 is depicted in FIG. 10. In operation 1002, a suitable photo resist is spun on, resist is exposed with a mask in operation 1004, resist is developed to remove unwanted material in operation 1006, and resist is baked to harden the final structure in operation 1008, where the lateral extent of the insulating layer may cover all the coil features and may cover all bottom yoke edges.

In continued examination of process 800, a third polymeric insulating layer is formed over the top of the coils in operation 814.

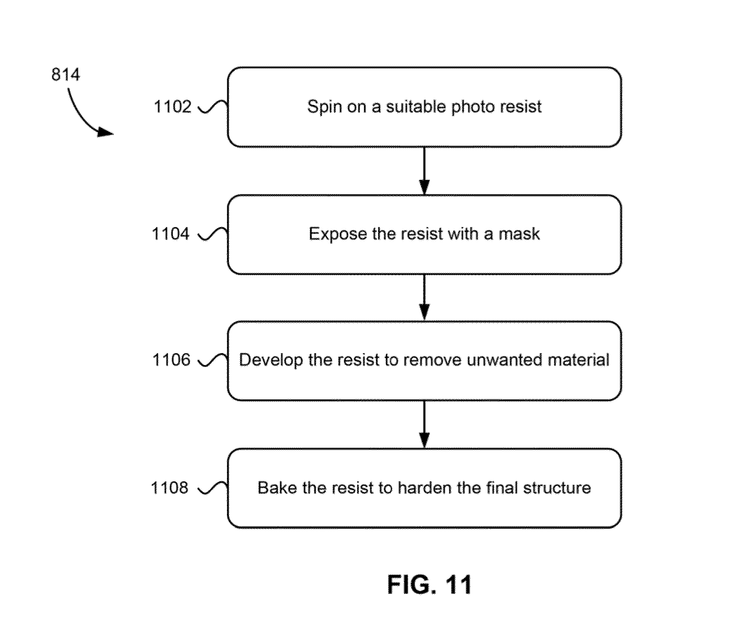

A possible process to perform step 814 of FIG. 8 is depicted in FIG. 11. A suitable photo resist is spun on in operation 1102 and resist is exposed with a mask in operation 1104. Resist is developed to remove unwanted material in operation 1106 and in operation 1108, resist is baked to harden the final structure, wherein the lateral extent of the insulating layer should cover all the coil features.

Referring again to the process 800 of FIG. 8, a top yoke is formed using a photo resist step to define plating areas in the shape of the top yoke in operation 816. The top yoke is plated and resist is removed in operation 818.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A thin film inductor, comprising:
a bottom yoke;
a first insulating layer above the bottom yoke;
one or more conductors above the bottom yoke and separated therefrom by the first insulating layer;
a second insulating layer above the one or more conductors;
a third insulating layer above the second insulating layer; and
a top yoke above the third insulating layer.

2. The thin film inductor as recited in claim 1, wherein the second and third insulating layers have different compositions.

3. The thin film inductor as recited in claim 1, wherein the second insulating layer includes at least one of an oxide, a nitride and a nonpolymeric material; wherein the third insulating layer includes at least one of a polymeric and an organic material.

4. The thin film inductor as recited in claim 1, wherein the first insulating layer includes two layers.

5. The thin film inductor as recited in claim 4, wherein the two layers of the first insulating layer each comprise a material selected from a group consisting of an oxide and a polymer.

6. The thin film inductor as recited in claim 1, wherein the thin film inductor is a non-coupled inductor wherein the one or more conductors are electrically connected together.

7. The thin film inductor as recited in claim 1, wherein the thin film inductor is a coupled inductor having two or more conductors of which at least two are not electrically connected.

8. A system, comprising:
an electronic device; and
a power supply or power converter incorporating a thin film inductor as recited in claim 1.

9. The system as recited in claim 8, wherein the thin film inductor and the electronic device are physically constructed on a common substrate.

10. The system as recited in claim 8, wherein the second and third insulating layers have different compositions.

11. The system as recited in claim 10, wherein the second insulating layer includes at least one of an oxide, a nitride and a nonpolymeric material; wherein the third insulating layer includes at least one of a polymeric and an organic material.

12. The system as recited in claim 8, wherein the first insulating layer includes two layers.

13. The system as recited in claim 8, wherein the first and third insulating layers include at least one of an organic and a polymeric material.

14. A thin film inductor, comprising:
a bottom yoke;
a first insulating layer above the bottom yoke, the first insulating layer being polymeric;
one or more conductors above the bottom yoke and separated therefrom by the first insulating layer;
an upper insulating layer above the one or more conductors, the upper insulating layer being polymeric; and
a top yoke above the second insulating layer.

15. The thin film inductor as recited in claim 14, further comprising a second insulating layer between the one or more conductors and the upper insulating layer, the second and upper insulating layers have different compositions.

16. The thin film inductor as recited in claim 15, wherein the second insulating layer includes at least one of an oxide, a nitride and a nonpolymeric material.

17. A system, comprising:
an electronic device; and
a power supply or power converter incorporating a thin film inductor as recited in claim 14.

18. The system as recited in claim 17, wherein the thin film inductor and the electronic device are physically constructed on a common substrate.

19. The system as recited in claim 18, further comprising a second insulating layer between the one or more conductors and the upper insulating layer, the second and upper insulating layers have different compositions.

20. The system as recited in claim 19, wherein the second insulating layer includes at least one of an oxide, a nitride and a nonpolymeric material.
